(19) United States
(12) Patent Application Publication
(10) Pub. No.: US 2022/0414773 A1
(43) Pub. Date: Dec. 29, 2022

(54) System and Method to Create and Trade Securities from Equity

(71) Applicant: Anand Bernard Alen, Flower Mound, TX (US)

(72) Inventor: Anand Bernard Alen, Flower Mound, TX (US)

(21) Appl. No.: 17/830,691

(22) Filed: Jun. 2, 2022

Related U.S. Application Data
(63) Continuation-in-part of application No. 17/383,480, filed on Jul. 23, 2021, now abandoned.
Application No. 17/383,480 is a continuation-in-part of application No. 17/384,862, filed on Jul. 26, 2021, now abandoned.
(60) Provisional application No. 63/215,497, filed on Jun. 27, 2021.

(51) Int. Cl. G06Q 40/04; G06Q 40/08

(52) U.S. Cl. CPC G06Q 40/04; G06Q 40/08

(57) ABSTRACT

An interactive computer network is encoded to allow asset owners to sell a future fraction of the equity of a real estate asset at the present time. The interactive computer network comprises a computer for receiving a current equity of a real estate asset, a computer for validating the current market price of the asset, and a computer for creating an offer-for-sale document for selling a future fraction of the equity and trading portal for sellers and buyers to interact with each other.

### CROSS-REFERENCE

This is a continuation-in-part Application to the U.S. patent application Ser. No. 17/383,480, filed on Jul. 23, 2021 and U.S. patent application Ser. No. 17/384,862, filed on Jul. 26, 2021, entitled “System and Method to Create and Trade Securities From Equity,” from which priorities are claimed, and the entirety of which are hereby incorporated by references. Priority is also claimed from the U.S. Provisional Patent Application No. 63/215,497 filed on Jun. 27, 2021, entitled “System and method to create tradable securities from equity”, the entirety of which is hereby incorporated by reference.

### DESCRIPTION OF RELATED ART

The present application relates to a computerized network system and method that creates and trades securities from equity, and more particularly to an electronic service system for providing enhanced artificial intelligence in creating and trading securities from equities in real estate properties.

Note that the points discussed below may reflect the hindsight gained from the disclosed inventions, and are not necessarily admitted to be prior art.

Problem scope: when the paper was written on Dec. 24, 2013, only 13% of mortgaged homes in the United States are “under water”, where their value is less than the sum of liens and that percentage is on a downward trend. So, the vast majority of home owners who have a mortgage have positive equity and the amount of equity per home is also on an upward trend. Further, ⅓ of all homes in the United States do not have a mortgage at all—they are owned free and clear. There are about 50 million mortgages and about 25 million homes owned free and clear. The median home value is $200,000 and the average equity in a mortgaged home is about 40% of its value. So, the total asset value of combined home equity in the United States is: 200,000×25,000,000+(200,000×40%)×50,000,000=9,000,000,000,000 or $9 trillion. That $9 trillion is illiquid and non-transactional and is essentially “sitting out of the economy”. Today, as of this filing, that number is $26.3 trillion. The only broad methods to liquidate home equity are to refinance or sell and in a much lesser volume, use reverse mortgages. These methods are not applicable to all owners with equity. For instance, wealthy owners who do not have a high income may not qualify for a refinance. As the life expectancy in the United States increases, reverse mortgages are less attractive to those recently retired. Enabling a person with high net worth or considerable equity in their real properties or other non-cash flow producing assets to create some liquidity out of their assets stimulates the economy as a whole.

Previously, there are Mortgage-Backed Securities and REITs that create an investment vehicle from cash flow generating assets. Unison.com now provides securitization of home equity; however, they do not offer an artificial intelligence enhanced and computerized marketplace for home equity sellers or buyers to trade with each other.

Problems solved: when the provisional patent application was written in 2014, there was no system or method in existence to create tradable securities from assets not intended to produce cash flow such as home equity. Though a couple of systems do provide that today, those are limited to very few selected properties. There isn't an artificial intelligence enhanced marketplace where homeowners can sell their equity for cash with fairness and there isn't a computer managed process where members of the public can purchase and sell such equity.

With this invention, a computer system with artificial intelligence is constructed to create tradable securities out of equity in people's homes. These homes could be owner occupied or rental homes. Cash flow is not a pre-requisite for these securities; however, cash flow does not preclude a property from participating in this system. Though this invention is written illustrating equity in US homes, the same idea is applicable globally and also to other situations with equity such as farm land, precious metals, art or any other perceivably appreciating asset.

### SUMMARY

The present application discloses a novel user interface and software platform at the application level to function as security trading network based on real estate equity values with artificial intelligence.

An example embodiment of the system builds a securities portal where an asset owner can declare his equity in the asset, sell a portion of his equity and receive cash compensation for it, a method for shares to be created out of the sold equity, method for the shares to be advertised and sold to buyers, method and system for such shares to be traded among the public, method for share value to be adjusted based on appreciation of the asset, method to record the agreement between the home equity seller and the securities buyer that the buyer will be compensated for the portion owned from the eventual sale of the home, a method to insure the contract against fraud, a method to insure the contract against home value loss. The portal also performs bookkeeping functions using blockchain technology such as registration of equity-sellers, share-purchasers, tracking outstanding shares and total share value assigned to each property and functions needed to enable variations to the solution and derivatives from the solution.

In the basic embodiment, a person who has equity in a property, equity-owner, decides to create and sell securities out of his equity on the portal. Equity is the value of the property minus sum of all liens on the property. The transactions are executed using the following steps and actions, includes computer software implementing functions for Declaration of Intent to Sell, Assessment of Property Value and Owner Equity, Equity-Owner Payment, Creation of Shares, Advertisement and Sale. Creation of Contract, Constructing a Secondary Market, Providing Security Insurance, Sale of Property and Gains, Recording the Release of Liens.

An example computer embodiment implements a Model View Controller architectural pattern for the processing of application data that are separate from the viewer and controller of the host machines. The presentation layer implements data instances that deliver an interface that implements the logic for processing user data and input.

An example embodiment of the portal network system includes collective intelligence data hubs for property value and equity assessment and for trading platforms. The data communication hub transforms the various user data components to be communicated through various computer components made up of web services, networks, and trading application services for performing TCP/IP related tasks as well as the utilization of many of computer communication protocols such as interactions with its own embedded databases and other internal databases via its domain network pool. It also wraps services, such as multiple computer transactions as a single executable binary.

In one embodiment, each network of profiled users act through an interconnected set of internal and external networks based upon role(s), the users will be assigned multiple user interfaces for its VLAN or wireless computer Network implementations such as Virtual Private Network (VPN), Internet and/or a Cellular Network Address, network protocols include Link Aggregation, IEEE 802.3 Standard, IEEE802.0 standard, layer 2 tunneling protocol (L2TP) over IPSEC or Internet Protocol Security.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1 schematically shows the timeline of computational events where the portal digitally buys the offered equity from the equity seller and compensates the equity seller before creating securities from the offered equity and placing those securities for sale on the market.

FIG. 2 schematically shows the timeline of computational events where the portal places the created securities on the market for the members of the public to purchase and compensates the equity seller as the securities are sold on the marketplace.

FIG. 3 schematically shows the computational system where the securities portal communicates with other prevailing and modified real estate, ledger, and insurance systems.

FIG. 4 shows an example computer interface for an equity seller account in submitting a contract as an equity seller to the system portal in accordance with this application.

FIG. 5 shows an example computer interface for an equity investment account in accordance with this application.

FIG. 6 shows an example computer interface for top level equity investment account in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

A “Component” is functional unit of the claimed software portal system that provides an actual transactional interaction realization with its results being stored either in database or displayed on a screen, through a set of user interfaces. It includes automated software user interfaces that comprises computer processors, computer memory and storage, binary code, executables, scripts that are packaged for performing the intended functions.

“Method(s) or process” term means a method for object oriented programming code whereas it performs a subroutine and is exclusively associated with a class or an object. Normally, consists of a sequence of programming statements to perform an action, a set of parameters to customize those actions, and possibly an output value (sometimes called a return value).

A “portal” means a set of multiple but unique methods (methodologies) for the automation of data network services, data communications, data storage, and data storage retrieval, Live Multimedia Streaming, Social Media Hubs, Collective Intelligence Hubs that can enable collective intelligence as stored business intelligence data, enabling a method that reverses the need for large data centers by enabling machine to machine connection with like-peers in blockchain technology.

“Web-Service” is an application layer service that executes via a public internet interface via TCP/IP. A web service is one that can be located, discovered, and published via a network channel. Additionally, a web service can also act as an intermediary business application service agent that is an encapsulated service provider, but can also be a service requestor. Normally, this type of service-agent acts as lightweight program executable that has a small memory footprint and can be custom developed. This component may not encapsulate a true web service as it does not have a WSDL endpoint, but will expose an internal, yet unique set of API libraries that will allow a single binary executable to “wrap” services so that tens of millions of requests can be granted at a time. With optimal load balancing being achieved a CPU is not taxed to the max as to crash a physical server disk or its domain network community. A “Web Service” generally means Services that are application oriented and encapsulate a business logic that executes an application as a business service.

For “Network Services”, there are two types. One type of “Network Services” mean file sharing services, file services, collaboration services, and messaging. They can also be located, discovered, and published. Another type of Network Service, taking the form of a Network Interface, implements a standard connection protocol, such as Ethernet, Wireless, etc.

“Service” means either a Network Service and/or Web Service.

A “Model View Controller” is an architectural pattern for the application data that are separate from the view and controller of host machines. The presentation layer implements its own views, as mirrored instances that deliver an interface that will implement the logic for processing user data and input on a locally virtual application server instance. It also wraps services, such as multimedia services as a generated instance of a single executable binary.

Additionally, it is contemplated and intended that the architecture not only functions in reverse of client serving computing, but also encapsulates and build application services through a service oriented architecture layer consisting of an application layer, a business service layer, and the orchestration layer. Then, the service models encompass utility services and wrapper services, etc., including their corresponding hardware components.

A system and method are described in this invention includes a specifically programmed hardware components that are functionally transformed into a securities portal—also simply knows as the portal henceforth—where an asset owner can declare his equity in the asset, sell a portion of his equity and receive cash compensation for it, a method for shares to be created out of the sold equity, method for the shares to be advertised and sold to buyers, method and system for such shares to be traded among the public, method for share value to be adjusted based on appreciation of the asset, method to record the agreement between the home equity seller and the securities buyer that the buyer will be compensated for the portion owned from the eventual sale of the home, a method to insure the contract against fraud, a method to insure the contract against home value loss. The portal also performs bookkeeping functions such as registration of equity-sellers, share-purchasers, tracking outstanding shares and total share value assigned to each property and functions needed to enable proposed variations to the solution and derivatives from the solution. In the basic embodiment, a person who has equity in a property, equity-owner, decides to create and sell securities out of his equity on the portal. Equity is the value of the property minus sum of all liens on the property. The system transactions and uses are described as in following steps and actions.

Step 1—Declaration of Intent to Sell: The equity-owner accesses an online portal made available to him for the purposes of this solution, identifies his property and declares an intent to create and sell shares for a percentage of his equity in the property. The portal is optionally capable of restricting how much—as a percentage—of his equity he is able to sell to create securities. For a single-family home in the United States, the property may be identified by its complete street address or legal description. The portal in addition may optionally require parameters that identify the financial strength of the equity-seller, his credit score, annual income, net worth or other parameters deemed necessary to create confidence in the system.

Step 2—Assessment of Property Value and Owner Equity: The portal may employ one of several methods to assess the value of the property submitted for security creation by the equity-owner. The options are stated value by equity owner, value assessed for purposes of property taxation, value as estimated by systems such as Zillow or other online automatic value assessment method, value as determined by a licensed real estate appraiser, value as determined by real estate brokers opinion, or any other method the portal deems appropriate. Owner equity may be optionally verified by cross-checking existing databases that track outstanding liens, obtaining a statement from the lending institution that has a current lien on the property or other methods suitable to the portal. The portal also has information about any prior equity sales associated with the property. The portal validates Property Value and Owner Equity through the Artificial Intelligence statistical analysis module that compares multiple geographic factors, property tax history, property built time, conditions of the property, information from government permits database and recent sales data, mortgage interest, etc. The artificial intelligence is constructed using several mathematical model, and is market tested, and tested by empirical data of appraisers for accuracy.

Step 3—Equity-Owner Payment: After the owner has declared an acceptable percentage of equity to be sold for share creation and the portal has assessed his property's value and equity position, the portal optionally registers a lien with existing registrars such as the property's county registrar so that the portal will be consulted if the property is offered for sale or encounters other encroachments that will interfere with the rights the portal earned through this transaction. In an embodiment, the equity-owner is compensated for his sold equity as cash minus applicable portal commissions and fees. In another embodiment, the shares as described below are created and sold and the owner compensated as the shares are sold.

Step 4- Creation of Shares: The portal creates shares from the sold-equity. The face value and number of shares are not fixed in the invention and are determined based on the portal's calculations of what provides best sale velocity. The portal may use factors such as location of property, amount of equity to convert to shares, availability of investors who may buy the shares and any other factor to arrive upon the number of shares and its face value. For the purposes of this invention, these shares are called primary market shares.

Step 5—Advertisement and Sale: The portal advertises these shares to qualified and accredited investors or investors who are otherwise allowed and eligible to purchase these shares or the members of the public. In an embodiment, the portal collects payment form the share-buyers and recuperates the amount paid to the equity-owner (or equity-seller as he is now). As there is a time period between when the portal paid the equity-owner and sells shares and collects cash from share-buyers, the portal is carrying a risk. This is a factor that the portal developer may use in calculating commissions and fees applied to this transaction. The share purchasers may also be charged a commission or fee. The portal has a motivation to sell these shares as quickly as possible. In another embodiment where the equity seller has not been paid, the portal credits the equity seller as the shares are sold. The portal's risk is reduced in this case.

Step 6—Creation of the contract: A contract is created between the home equity seller and the securities buyer conferring a portion of the future sale price as determined by the number of securities the buyer purchased when the home sells. This contract is also transferrable to the new buyer of the home if the new buyer agrees.

Step 7—Secondary Market: The securities obtained by a securities buyer as stated in the above paragraph can be sold on the platform to others who want to purchase the securities for presumably a higher price than what the securities buyer bought it for. The securities buyer can also “offload” these securities for a lower price than what they bought it for to cash out. When securities are traded in this manner, the contract between the home equity seller and the securities buyer is updated to reflect the new securities buyer.

Step 8—Securities Insurance: Along with the securities, the platform also offers insurance that the security buyer can purchase. Two kinds of insurance products are offered: first is one that protects the security buyer against fraud. An example of fraud is where the home equity seller, sells the property and does not compensate the portal for distributing gains to the securities holder. In this case, the provider of the insurance—“the insurance company”, compensates the security buyers who bought this insurance and then has the option to take legal action against the seller for violation of contract. The second kind of insurance provided on the platform insures against an agreed upon minimum value of the future sale price of the home or a rate of return for the securities buyer on the value of their securities. It is expected that in this second kind of insurance, where the year-over-year appreciation of homes is about 10%, the assured rate of return could be a lower 3% and all the upside is to the insurance company and they get this reward for taking the risk to at least provide 3% to the securities buyer. It is expected that the second kind of insurance is built on-top of the first.

Step 9—Sale of Property and Gains: In an embodiment, when the property from which equity-shares were created as described in this invention sells, the ratio of the value of the property at point of sale to the value of the property at point of share creation is applied to the sold-equity. The resulting amount is handed to the portal by the home equity seller. Where a lien was created, the lien is released. The portal then assigns the proceeds to be distributed as gains to the securities holders. In an alternate embodiment, distributing funds to the portal at the point of sale is done by the closing company involved in the home sale closing transaction.

Two operation models are presented. First model is that the portal digitally buys the offered equity from the equity seller and compensates the equity seller before creating securities from the offered equity and placing those securities for sale on the market. Second model is that the portal places the created securities on the market for the members of the public to purchase and compensates the equity seller as the securities are sold on the marketplace.

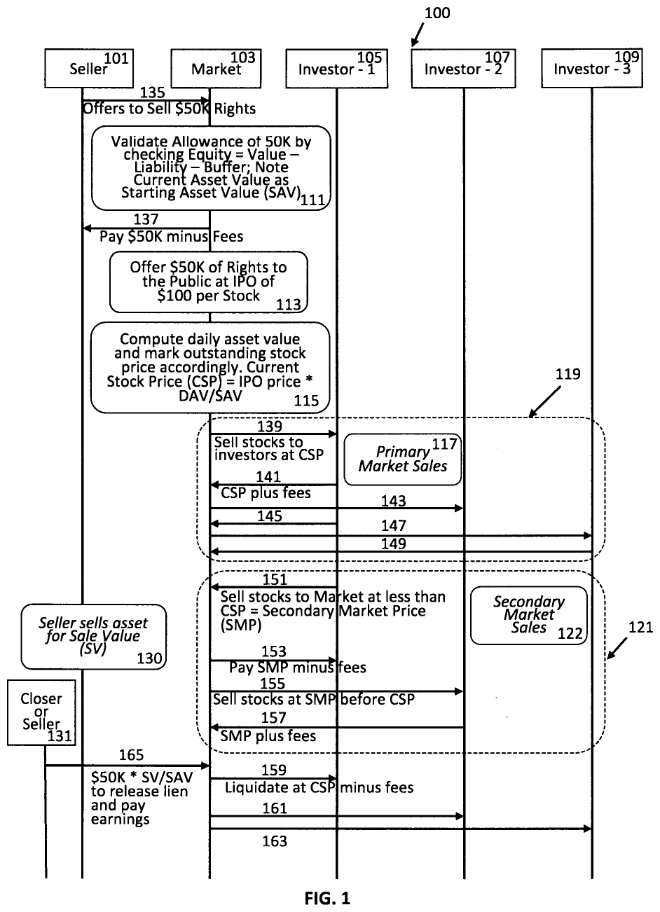

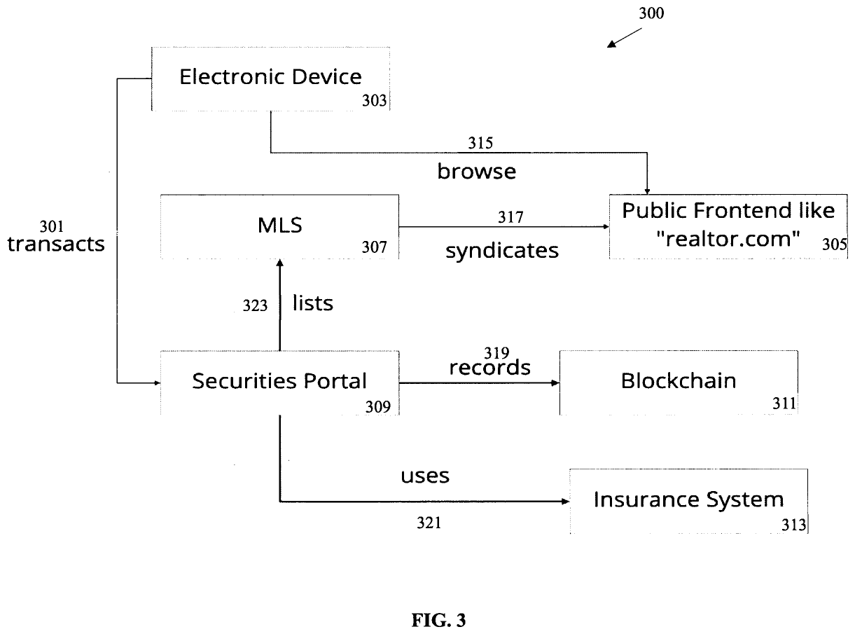

In reference to FIG. 1 and FIG. 3, when the portal digitally buys the offered equity from the equity seller and compensates the equity seller before creating securities from the offered equity and placing those securities for sale on the market, an example flow narrative of computer implementation is described as follows:
1) A real estate agent meets with a home owner 101 and asks him if he wants to sell his house.
2) Given the appreciated market, the home owner 101 would love to sell the house and avail of the cash, but feels that the process of selling, purchasing another home in this up market and then relocating his family is something he can't afford in time and out-of-pocket money. It will also cause a lot of inconvenience to his family and children.
3) The real estate agent then asks him if he would be willing to sell 10% of the home instead and proceeds to describe how he can sell a portion of his equity and get cash now—that essentially, he's agreeing to share a portion of the future sale value of the house and investors 105, 107, 109 are also interested in participating in its appreciation.
4) The home owner 101 agrees (or alternatively, offers to sell at step 135) to sell 10% of the future sale value of the house and the real estate agent logs on to the portal 100 and registers the deal. Deal parameters are property identity, owner information and the agreement to sell 10% of future or current sale value.
5) The portal 100 lists this as a new listing type on the regional Multiple Listing Systems (MLS). The MLSs syndicate this listing as they do for other listings with realtor.com, zillow.com, homes.com and other brokerage front ends.
6) The portal 100 also evaluates the property's current value to be $400,000 on the market 103 using the method and values retrieved from realtor.com, zillow.com, homes.com described in steps above and records the value at the agreement date.
7) In the first model, Portal 100 immediately buys the 10% of the current property value at step 137 and pays seller 101 the 10% of the current property value, which is $40,000 minus fees.
8) The portal 100 then creates securities from this agreement for an artificial $100 face value each (or determined by other market factors) and lists these securities for sale on the portal 100. For example, if the property was worth $400,000 at step 111 as Starting Asset Value (SAV) and the agreement was to share 10% of its future sale value with security buyers, then at $100 face value as IPO for the $40k as security rights, the portal creates and lists 400 securities for sale at step 113. While the securities remain for sale on the portal 100, the portal 100 updates the securities market value, Current Stock Price (CSP)=IPO price*DAV/SAV, DAV as the daily asset value, to reflect current market value of the property at step 115. For instance, if the property appreciated to $404,000 then each security's market value would be $101 at step 115, the Current Stock Price (CSP)=IPO Price*DAV/SAV, where DAV is the daily asset value.
9) The FIG. 3 shows the security portal 309 records at step 319 the property information, value, owner information, agreement and all securities created on a Blockchain 311. The agreement is created as a Smart Contract on the Blockchain where all securities are created as fractional NFTs also known to those in the art as Stackable Tokens.
10) A member of the public notices that she can purchase 10% of a property on realtor.com. She clicks on the link included with the listing and is directed to the portal 100.
11) On the portal 100, the member 105 of the public is shown historic performance of the property, the neighborhood and the zip code among other parameters like tax records, zoning and other information an investor would like to see on the portal 100. Also, included are projections on how the property is expected to do in the future and calculators where the member of the public can estimate their returns and fees based on their investment size.
12) Based on all the information shown, investor 105 decides to purchase 40 tokens (securities) for $4000 plus fees at step 139. She now effectively owns 1% of the future value of the home when it sells.
13) She also purchases insurance to protect her against seller-non-performance, which will cover her if the seller decides to not pay the securities holders when he sells the house.
14) Eventually other token buyers (107, 109) buy all the remaining tokens through process 143 and 147, and the entire primary trading processes 119 can be repeated for the remaining tokens at the Primary Market 117.
15) Secondary Market: the primary investors 105, 107, 109, those who purchased shares from the portal 100 in the primary market 117, may be allowed to sell the shares to other buyers via portal 100 or other portals through secondary market processes 121. With processes 121 on secondary market 122, for the purposes of this example, this is the secondary market 122 for these shares. The share value sold in the secondary market 122 appreciates or depreciates simply based on supply and demand for these shares and in an embodiment is disconnected from the property's market value. In another embodiment, the shares are transferrable but not tradeable, their market value is determined by the property's market value—that is the shares are always market-to-market, for example, investors 105, 107, 109 can trade between them through process 151, 153, 155, 157 through portal 100. For example investor 105 sells back the shares at Secondary Market Price (SMP) to portal 100 through process 151, the portal 100 pays investor 105 with SMP minus fees, then portal 100 then sells the shares to investor 107 through process 155 at another SMP, and investor 107 pays at SMP plus fees.
16) The portal 100 closes the security listing on the regional MLS if it was listed there as “Sold” with the sale price as the sum of prices of all tokens sold.
17) The portal 100 also starts scanning the MLS for this property to check if this property is placed on market for sale.
18) If two years later, the owner 101 becomes seller at step 130 and lists the house for sale for $480,000.
19) The portal 100 picks up that the property has been listed for sale and sends a note to the seller 101 reminding the seller of the presence of the agreement to share 10% of the sale value with securities (token) investors. The portal optionally advises the listing agent on record for selling the property, the listing broker and the closing/title company at step 131.
20) The seller 101 sells the house for $480,000 as Sale Value (SV) at step 130 and funds the portal 10% which is $48,000 minus fees through process 165.
21) The portal 100 settles with the token holders at $120 per token through process 159, 161, and 163, which is a 20% return over that two-year period, for investors 105, 107, 109.

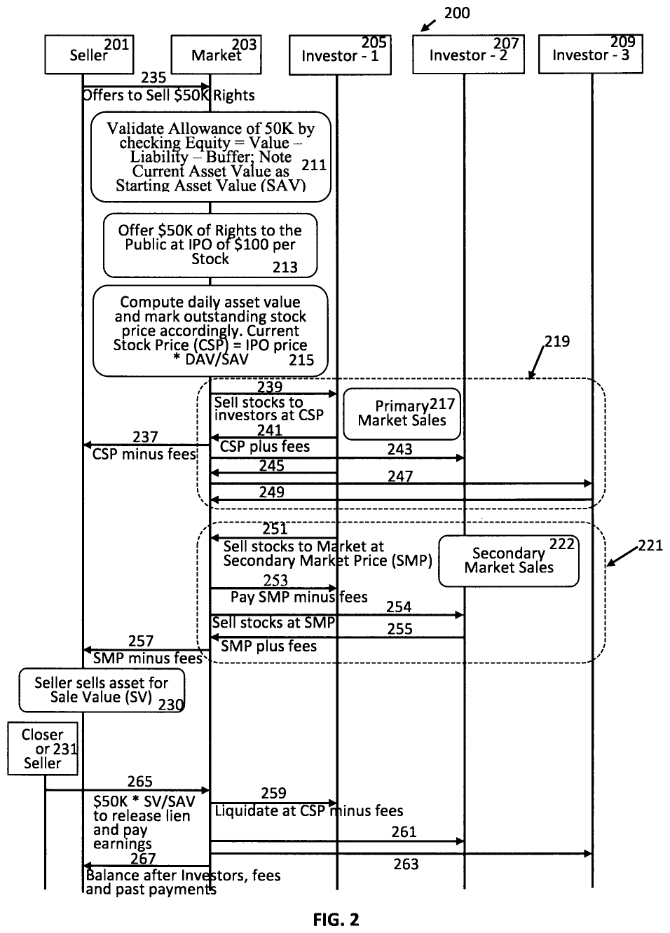

In reference to FIG. 2, for the second model where the portal first places the created securities on the market for the members of the public to purchase and only compensates the equity seller as the securities are sold on the marketplace, an example flow narrative of implementation is described as follows:
1) A real estate agent meets with a home owner 201 and asks him if he wants to sell his house.
2) Given the appreciated market, the home owner 201 would love to sell the house and avail of the cash, but feels that the process of selling, purchasing another home in this up market and then relocating his family is something he can't afford in time and out-of-pocket money. It will also cause a lot of inconvenience to his family and children.
3) The real estate agent then asks him if he would be willing to sell 10% of the home instead and proceeds to describe how he can sell a portion of his equity and get cash now—that essentially, he's agreeing to share a portion of the future or current sale value of the house to investors, for example investors 205, 207, 209 who want to participate in its appreciation.
4) The home owner 201 agrees to sell 10% (or offer to sell) of the future sale value of the house and the real estate agent logs on to the portal 200 and registers the deal at step 235. Deal parameters are property identity, owner information and the agreement to sell 10% of future sale value.
5) The portal 200 lists this property and offer as a new listing type on the regional MLS. The MLSs syndicate this listing as they do for other listings with realtor.com, Zillow.com, homes.com and other brokerage front ends.
6) The portal also valuates at step 211 the property's current market value as Starting Asset Value (SAV) to be $400,000 on the market 203 using data and any method described in realtor.com, Zillow.com, homes.com and records the value at the agreement date.
7) The portal 200 then creates securities from this agreement with an artificial $100 face value each as IPO and lists these securities for sale on the portal 200. If the property was worth $400,000 at 211 and the agreement was to share 10% of its future sale value with security buyers, $100 face value IPO securities are offered, the portal creates and lists 400 securities for sale at step 213. While the securities remain for sale on the portal, the portal 200 computes and updates the securities market value, Current Stock Price (CSP)=IPO Price*DAV/SAV, DAV is the daily asset value of the property to reflect current market value of the property at step 215. For instance, if the property appreciated to $404,000 then each security's market value would be $101 at step 215.
8) The FIG. 3 shows the portal 309 records at step 319 the property information, value, owner information, agreement and all securities created on a Blockchain 311. The agreement is created as a Smart Contract on the Blockchain where all securities are created as fractional NFTs also known to those in the art as Stackable Tokens.
9) A member of the public notices that she can purchase 10% of a property on realtor.com or a similar website where properties are listed for sale or rent. She clicks on the link included with the listing and is directed to the portal 200.
10) On the portal 200, the member 205 of the public is shown historic performance of the property, the neighborhood and the zip code among other parameters like tax records, zoning and other information an investor would like to see on the portal 200. Also, included are projections on how the property is expected to do in the future and calculators where the member of the public can estimate their returns and fees based on their investment size.
11) Based on all the information shown, investor 205 decides to purchase 40 tokens (securities) for $4000 plus fees at step 239. She now effectively owns 1% of the future value of the home when it sells.
12) She also purchases insurance to protect her against seller-non-performance, which will cover her if the seller decides to not pay the securities holders when he sells the house.
13) Eventually other token buyers (e.g. 207, 209) buy all the remaining tokens through process 219 that is repeated for the remaining tokens at the Primary Market 217.
14) After all 400 shares of the stocks or tokens are sold, the portal 200 pays seller 202 the 10% property interest at then CSP price minus fee at step 237 or alternatively the Secondary Market Price (SMP) minus fee at step 257.
15) Secondary Market: The primary investors 205, 207, 209 (those who purchased shares from the portal 200) may be allowed to sell the shares to other buyers via portal 200 or other portals. With repeating process 221 on secondary market 222, for the purposes of this example, this is the secondary market 222 for those 400 shares. The share value sold in the secondary market 222 appreciates or depreciates simply based on supply and demand for these shares and in an embodiment is disconnected from the property's market value. In another embodiment, the shares are transferrable but not tradeable in the sense, their market value is determined by the property's market value—that is the shares are always market-to-market, for example, investors 205, 207, 209 can trade between them through processes 251, 253, 254, 255 through portal 200. For example, investor 205 sells back to portal 200 through process 251 at SMP and receives payment at SMP minus fees at step 253, portal 200 then sells to investor 207 through process 255 at SMP and receives payment through process 254 at SMP minus fees.
16) The portal closes the security listing on the regional MLS if it was listed there as “Sold” with the sale price as the sum of prices of all tokens sold.
17) The portal also starts scanning the MLS for this property to check if this property is placed on market for sale.
18) Two years later, the owner becomes seller at step 230 and lists the house for $480,000.
19) The portal 200 picks up that the property has been listed for sale and sends a note to the seller 201 reminding the seller of the presence of the agreement to share 10% of the sale value with securities (token) investors. The portal optionally advises the listing agent on record for selling the property, the listing broker and the closing/title company at step 231.
20) The seller 201 sells the house for $480,000 at step 230 and funds the portal 10% which is $48,000 minus fees; and releases lien at step 265.
21) The portal settles with the token holders at $120 per token, which is a 20% return over that two-year period, for investors 205, 207, 209 at steps 259, 261, 263.

### A Numeric Example

The above steps are illustrated with an example:
Value of the property at point of security creation (Vc)=$400,000;
The subscript c denotes values when equity was converted to shares;
Sum of all liens on the home (Lc)=$200,000;
Owner Equity (Ec)=$200,000.
Tradable Equity (TEc)=$100,000 (in this example, this portal allows 50% of owner equity to be traded).
Share Value as determined by Portal (Sc)=$10,000;
Number of Shares (NSc)=TEc/Sc=10;
Total Share Value (TSc)=NSc*Sc=$100,000 (normally this is the same as TEc, however circumstances may require the portal to increase or decrease this to sell the shares).
When the property sells:
The subscript ‘s’ denotes numbers at the point of sale of the property.
Sale Price of Property (Vs)=$500,000;
Sum of all liens (Ls)=$200,000 (for simplification and as it is largely immaterial to our discussion we use an interest-only loan model);
Appreciation (As)=Vs/Vc=$500,000/$400,000=1.25.
Total Share Value at Point of Sale (TSs)=TEc*As=$100,000*1.25=$125,000;
Share Value (Ss)=TSs/NSc=$125,000/10=$12,500;
Gain (Gs)=Ss−Sc=$12,500−$10,000=$2,500;
Owner's Cash on Sale (Cs)=Vs−Ls−TSs=$500,000−$200,000−$125,000=$175,000.

In this illustration the total cash proceeds received by owner is $175,000+$100,000=$275,000. If the owner had not participated in the system and sold his equity, he would have received $500,000−$200,000=$300,000. The difference of $25,000 is the price the owner is paying for the benefit of drawing cash from his otherwise illiquid asset much before sale. The investors made $2,500 each.

In reference to FIG. 3, electronic data process 300 is shown. Property data, and equity to security transaction data and user data 301 are received from electronic devices 303 through public frontend 305 and browsers 315 to security portal 309 computer system. The received data are processed according to the designated functional component and are sorted and outputted to MLS 307 which are displayed to 305. Processed data in accordance to the inventive processing methods are outputted as smart contract for storage in a blockchain network 311. Blockchain network 311 comprises of a core network computers involved in providing the equity based security trading networks. Security portal 309 computer system also comprises a communication function to insurance system 313.

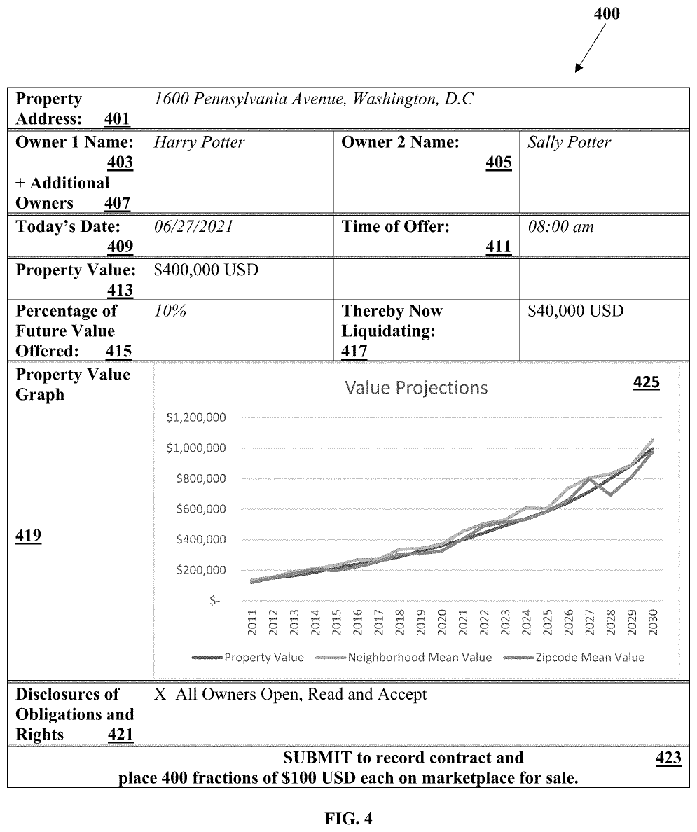

In reference to FIG. 4, a computer interface 400 for submitting an equity sale contract to the portal system includes information about the property address 401, owners' names 403 and 407, today's date 409, time of offer 411, property current market value 415, the percentage of the future value offered 415, the equivalent value offered if now liquidating 417, the history of value graph 419 and 425 displays the property's history and value projections. Disclosure and obligations section 421 list the documents of disclosures and obligations for signature and section 423 contains the submitting button for submitting an offer of equity for sale

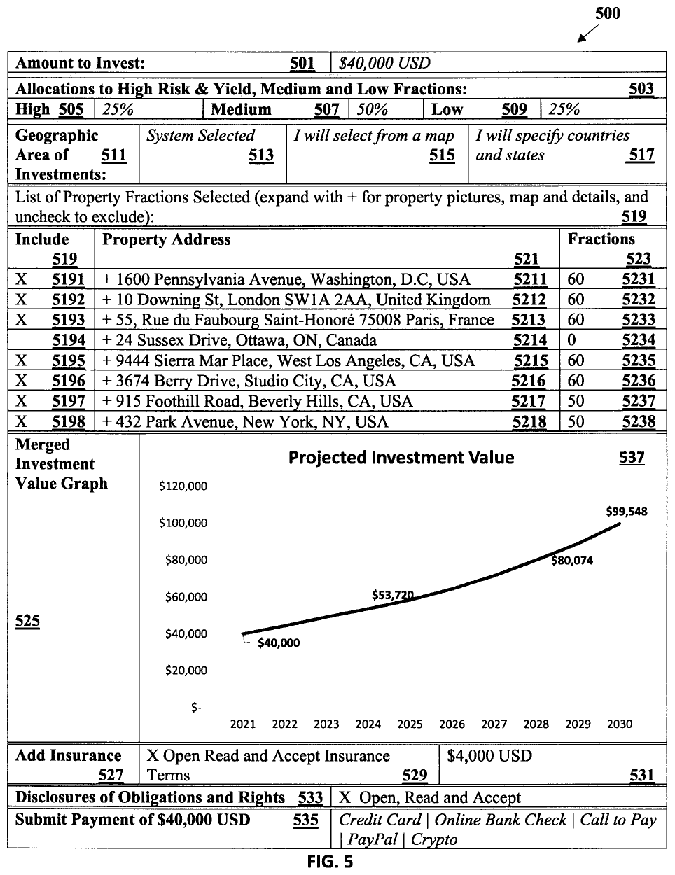

In reference to FIG. 5, a computer interface 500 for an investment account includes Amount to Invest 501, for example presently $40,000 USD, Allocations of Risk & Yield 503, for example, 25% high risk 505, 50% medium risk 507, and 25% low risk 509. The interface allows for specifying geographic area of investment (511), system selected (513), “I will select from a map” (515) and “I will specify countries and state” (517). In section 519, it lists available investment properties address (521) and the equity fractions (523). In section 525 and 537, it graphically displays the projected investment value over time. Section 527 allows for adding an insurance and allows for Open and Read Insurance Policy at section 529 and the amount of insurance policy in 531. Section 533 lists the Disclosure of Obligations and Rights for reading and acceptance, and 535 is the Submission button for making payment for this investment.

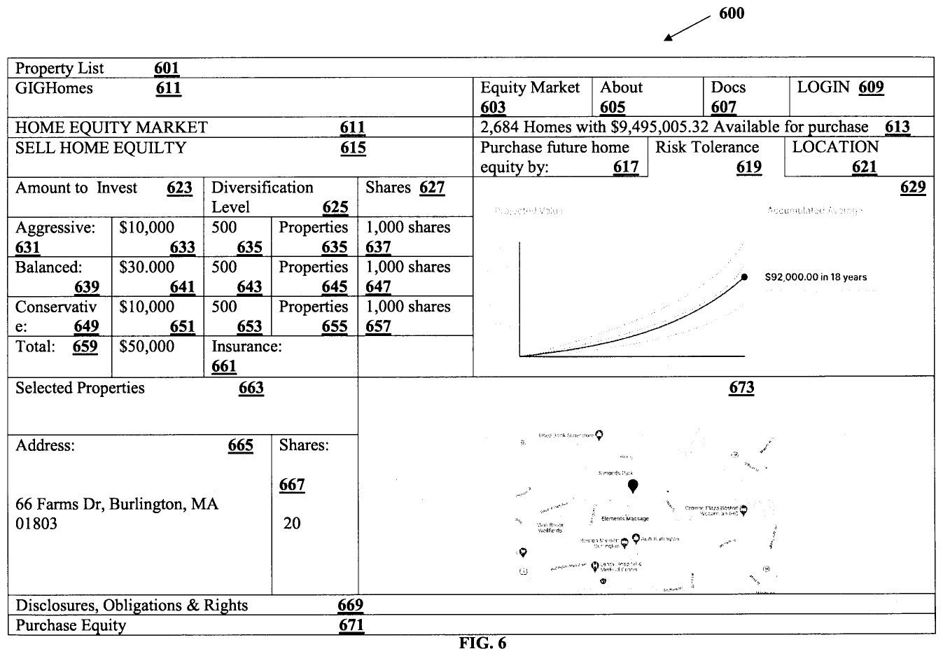

In reference FIG. 6, a computer interface 600 for a top level portal website for an equity investment account includes choice for property list (601), choice for GIGHomes (611), choice for equity market (603), choice for about (605), choice for Documents (607), choice for Login (609), choice for Home Equity Market (611), choice for available Homes for equity purchases (613), choice for Amount to Investment 623, Diversification level 625, Shares 627, display of selected property 665 and 673, Disclosure and Obligations 669, and choice for Purchase Equity (671).

Blockchain

Several new software objects are defined: “hashlib” is imported for the encryption, JSON library is used to format the blocks, and time for each block's timestamp.

“chain”: an empty list to add blocks to.

“pending_transactions”: when users send our transaction object to, their transactions will sit in this array until it is approved & add them to a new block.

“new_block”: this is a method defined to add each block to the chain.

“new_transaction( )” method with several most important variables: Equity Seller, Equity Buyer and Tradable Equity, Owner Equity, Share Value, Number of Shares, Total Share Value, Appreciation, Total Share Value at Point of Sale. Blockchains use SHA-256, an encryption hash function, which takes in some text string (stored as a Unicode value) and spits out a 64-character long encrypted string.

### VARIATIONS

In addition to the simple embodiment above, several variations are described here that extend the embodiment and are seen as the more likely methods this invention will be deployed and used.

Pooling: This variation modifies the basic embodiment by employing not one but a pool of properties whose owners have declared to sell their equities. Such pools may be created based on owner profiles, property locations, communities the properties belong to, property appreciation expectation models, property type (single family vs condominiums), properties in gated communities, under home owner associations or several other factors. Pools may also be created or formed by the portal based on securities buyer behavior or explicitly created and shared by securities buyer. Pooling may create a time period when similar properties may be accumulated before shares can be created. These shares now represent a portion of the value of the combined equity in the pool. The total value of these shares is the value of the pool. Pools may optionally require the same maximum equity-to-cash conversion percentage or a fixed equity-to-cash conversion percentage. Even when properties are pooled, applicable gains from appreciation at point of property sale are individually dispatched to the portal for further processing by the portal.

Impact on Variations from Property Sale. When properties are pooled as described in variation 1 effect of a single property sale is indirect. Pool values may be adjusted on a predefined schedule, such as every quarter of the year and property sales that have occurred in that period contribute to the adjustment. For example, if a similar type and size of properties in similar kinds of neighborhoods are in a pool, then the average sale price per square foot for the period may be used in computing the total adjustment for the pool value.

Application of Pool Value to Primary and Secondary Market Shares. After the pool values are adjusted, where there is only a primary market of shares, the face value of those shares is correspondingly increased or decreased. Where there is a secondary market, a considerable appreciation of pool value may result in a dividend optionally paid to the secondary market share holders from the funds collected over a period of time from property sales. Where there is a depreciation in value when property sells, it is expected that as secondary market shares are traded, the share value will implicitly decline resulting in appropriate losses for the secondary market share holders.

No Distribution at Point of Sale. In the simple embodiment, funds are distributed to primary market share holders when the property sells. Where there is a secondary market, a dividend may be optionally paid from property sale proceeds. In this variation, instead of distributing the funds to the primary or secondary market shareholders, the portal retains the funds as that property's or where the properties are pooled, that pool's “community investor share”. Where a secondary market does not exist, the portal must be able to distribute funds from this community investor share to primary market share holders on demand and adjust the community investor share accordingly. Alternately, the portal allows for the new purchaser of the property to inherit the contract between the home-equity seller and the collection of share owners, thereby deferring the need to settle at the point of sale. This process allows for the new home purchaser to effectively secure the home at a lower price or a lower down payment.

Zero Equity/Appreciation Rights. The invention also applies where at the start the home owner has no equity at all in the asset and is also not expecting to grow an equity in the asset by making principal payments to a lender. What's tradeable in this scenario is the appreciation and merely the current or future equity portion that the home owner gets through appreciation alone. As a portion of future value is sold to share buyers, there is no need for the home-owner to have current equity in the property when shares are created. The agreement is to simply share a portion of future sale.

Rate of Equity through Principal Reduction. Where the homeowner is making principal reductions and his equity growth is faster than that or others, the invention allows for the share values to grow above the asset appreciation rate to entice more participation from the share buying community. This creates share demand, which will in turn entice the asset owner to make more equity available to be sold through this invention as shares. The reverse of the above is also allowed by this invention where if the principal reductions are slower or missed, the share value growth can be computed below the asset appreciation rate to show more risk to the share buying community.

Portal is a Pass Through. As shown in Diagram 1 and Diagram 2, the solution and all variations above can operate where the portal is the broker and transacts with the principal equity-seller or the portal can be a pass-thru where it enables share buyers to transact directly with the principal and facilitate creation and trading of fractional shares on behalf of the equity seller.

Other assets. This method and its implementation are not limited to residential real estate assets but is applicable to commercial real-estate assets or digital and virtual assets such as art, music, intellectual property, creative work or assets in the Metaverse.

Impact of Community Investment Share on Cash to Purchase Property. When a portal retains and maintains a community investor share or where the existing contract to share future appreciation between the home owner (also the equity seller) and the collection of security buyers is transferred to the new home buyer, that share is taken out of purchase price of that property or in the case of a pool whatever proportion applies to a single property in that pool. This reduces the cash to close for that property. From the simple embodiment illustration above, the new purchase for the property will pay:

Vs−TSs=$500,000−$125,000=$375,000

As is normal, assuming an 80% loan to “value” where value in this calculation is the reduced price and not the value of the property at time of sale, the property purchaser will need a cash to close of $375,000*20%=$75,000. Without the community investor share applied, the purchaser would have had to bring a cash to close of $500,000*20%=$100,000. This makes home buying more affordable and does not add the risk of lower skin in the game as the community of investors have their vested interests. Akin to homeowners' associations it is expected that the community of investors will have a body overseeing their investment. Their motivation is aligned with the lenders. Therefore, in this model, we have a three-body system that can cross check and counter balance each other.

Consideration for other Liens on Property. As this invention proposes shares, it is assumed that they are of a lesser standing than debt-based liens that may be on the property. In the event of a foreclosure, the primary lien holder recovers the property and attempts to sell the property in a foreclosure auction. After a sale, the seller may be compensated for built-up equity based on applicable contracts and laws. From the balance, both primary and secondary market share holders may be compensated. It is conceivable that in a foreclosure event, the primary and secondary market share holders will lose their investment just as the home owner might. Pooling reduces the direct impact from a single foreclosure as the foreclosure merely results in a possible reduction in market value of the kind of properties that constitute the pool. In the most likely embodiment of this invention, there will be pools and there will be a secondary market, so the impact of foreclosures is marginalized as long as there is not an unusual amount of foreclosures in a pool. Collection of parameters to determine owner's financial strength at the time of share creation by the portal is to mitigate and correctly evaluate this risk.

Mitigating Foreclosures with this Method. When a home owner is in default, lenders can now use the method in this invention to take the rights to collect a portion of the future sale value of the house and sell that on the platform as securities, collecting either what's owed, what's in default or any other portion they deem good to address their risk, thereby allowing the home owner to continue to own the property. This allows lenders to not enter into an expensive foreclosure process or to take possession, evict and manage the property and possible tenants, none of which is the core of their business.

Derivatives. It is expected that derived financial instruments such as options to buy and sell primary or secondary market shares described in this system, mutual funds created by pooling shares from different pools and other investment methods will be created. The system does not preclude creation of any of these derivatives.

Laws. It is conceivable that some country, state or community laws or regulations may disallow portions of this invention and existing laws may have to be modified to accommodate parts of this system. It is expected that embodiments will be limited accordingly based on where they are implemented and governed.

Values of the System. The system allows anyone to potentially participate in the appreciation of a neighborhood without having to purchase a property in that neighborhood (which is the only method available today). This enables people to participate in real property appreciation with smaller investment amounts and so broadens the investor base.

With the “community investor share” variation, the system allows homes to be bought with lower cash to close while providing for a method to preserve property value by way of investor participation.

Provides for great liquidity by tapping into unrealized wealth and creating economic transactions from it. With the foreclosure mitigation method discussed provides stability to the real estate market.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. The method of providing an interactive computer network for trading a future fraction of an asset equity between an asset equity seller and an equity investor, comprising the steps of:
encoding a computer device on an electronic network for receiving a current equity in said asset;
encoding a computer device on the electronic network for retrieving market data from other electronic networks to validate the current equity through an Artificial Intelligence statistic analysis module with a weight factor for geographic location;
encoding a computer device on the electronic network for receiving a future fraction of the equity as an offer-for-sale document at a present date;
encoding a computer device on the electronic network for constructing a digital document recording the offer-for-sale document, the asset, the asset seller and the present date;
encoding a computer device on the electronic network for converting said offer-for-sale document into a set of unique digital symbols, each symbol representing a unit price; and
encoding a computer device on the electronic network for trading the digital symbols at the unit price to the equity investor;
encoding a computer device on the electronic network
whereby said method converts the future fraction of the asset equity into a present investment asset.

2. The method of claim 1, further comprising the steps of:
encoding a computer device on the electronic network to record a trading of the digital symbols as a digital document;
encoding a blockchain with an encryption function on said electronic network for recording the digital document; and
storing a copy of said blockchain on every computers of said electronic network.

3. The method of claim 1, wherein the digital symbols are NFT tokens.

4. The method of claim 1, wherein the digital symbols are stock stickers.

5. The method of claim 1, wherein said asset is real estate asset.

6. The method of claim 1, further comprising the steps of:
encoding a computer device on the electronic network for recording the digital document to be e-filed as a lien to a deed recording system.

7. The method of claim 1, further comprising the steps of:
encoding a computer device on the electronic network for retrieving the offer-for-sale document associated with the digital symbols; and
encoding a computer device on the electronic network for calculating a payment to the equity investor based on the offer-for-sale document upon a notice of asset sale either at present time or in the future time from the asset seller.

8. The method of claim 2, further comprising the steps of:
encoding a computer device on the electronic network for the equity purchaser to purchase an insurance policy for the trading.

9. The method of claim 1, further comprising the steps of:
encoding a computer device on the electronic network for trading the digital symbols at a market price between different equity investors.

10. An interactive computer network for trading a future fraction of an asset equity between an asset seller and an equity investor, comprising:
a computer device encoded on the electronic network for receiving a current equity in said as set;
a computer device encoded on the electronic network for retrieving market data from other electronic networks to validate the current equity;
a computer device encoded on the electronic network for receiving a future fraction of the equity as an offer-for-sale document at a present date;
a computer device encoded on the electronic network for constructing a digital document recording the offer-for-sale document, the asset, the asset seller and the present date;
a computer device encoded on the electronic network for converting said offer-for-sale document into a set of unique digital symbols, each symbol representing a unit price; and
a computer device encoded on the electronic network for trading the digital symbols at the unit price to the equity investor;
whereby the interactive computer network converts the future fraction of the asset equity into a present investment asset.

11. The interactive computer network of claim 10, further comprising:
a computer device encoded on the electronic network to record a trading of the digital symbols as a digital document; and
a blockchain built on said electronic network with an encryption function for recording the digital document.

12. The interactive computer network of claim 10, wherein the digital symbols are NFT tokens.

13. The interactive computer network of claim 10, wherein the digital symbols are stock stickers.

14. The interactive computer network of claim 10, wherein said asset is real estate asset.

15. The interactive computer network of claim 10, further comprising:
a computer device encoded on the electronic network for recording the digital document to be e-filed as a lien to a deed recording system.

16. The interactive computer network of claim 10, further comprising:
a computer device encoded on the electronic network for retrieving the offer-for-sale document associated with the digital symbols; and
a computer device encoded on the electronic network for calculating a payment to the equity investor based on the offer-for-sale document upon a notice of asset sale either at present time or in the future time from the asset seller.

17. The interactive computer network of claim 11, further comprising:
a computer device encoded on the electronic network for the equity purchaser to purchase an insurance policy for the trading.

18. The interactive computer network of claim 10, further comprising:
a computer device encoded on the electronic network for trading the digital symbols at a market price between different equity investors.
